(19) United States
(12) Patent Application Publication
(10) Pub. No.: US 2025/0355393 A1
(43) Pub. Date: Nov. 20, 2025

(54) SERVER AND IMAGE FORMING APPARATUS

(71) Applicant: Toshiba Tec Kabushiki Kaisha, Tokyo (JP)

(72) Inventor: Takao IZUMI, Yokohama Kanagawa (JP)

(21) Appl. No.: 19/077,808

(22) Filed: Mar. 12, 2025

(30) Foreign Application Priority Data
May 20, 2024 (JP) 2024-081987

(51) Int. Cl. G03G 15/00; G06F 3/12

(52) U.S. Cl. CPC G03G 15/556; G06F 3/1219; G06F 3/1229; G06F 3/1286; G06F 3/1287

(57) ABSTRACT

According to one embodiment, a server for a printer system includes a communication interface and a processor. The communication interface receives, from an external image forming apparatus, a first number of standard printable sheets of an installed toner cartridge, a first average print ratio for the toner cartridge, a first average number of printed sheets per day for the first toner cartridge, and a first remaining amount of toner in the installed toner cartridge, and transmits at least one of a number of remaining printable sheets or a number of remaining printable days to an external information terminal. The processor calculates the number of remaining printable sheets and the first number of remaining printable days based on the first number of standard printable sheets, the first average print ratio, the first average number of printed sheets, and the first remaining amount of toner.

### CROSS-REFERENCE TO RELATED APPLICATION

This application is based upon and claims the benefit of priority from Japanese Patent Application No. 2024-081987, filed May 20, 2024, the entire contents of which are incorporated herein by reference.

### FIELD

Embodiments described herein relate generally to a server and an image forming apparatus.

### BACKGROUND

An image forming apparatus that displays a remaining amount of toner of a toner cartridge in the apparatus in percent values is known.

### BRIEF DESCRIPTION OF THE DRAWINGS

FIG. 1 depicts a printing system including a plurality of image forming apparatuses according to a first embodiment.

FIG. 2 is a schematic view of an image forming apparatus.

FIG. 3 depicts aspects of an image forming unit of an image forming apparatus.

FIG. 4 is a block diagram showing of an image forming apparatus.

FIG. 5 is a conceptual diagram depicting data stored in an auxiliary storage device of an image forming apparatus.

FIG. 6 is a block diagram of a server.

FIG. 7 is a block diagram of a serviceman terminal.

FIG. 8 is a sequence diagram showing an example of an operation of a printing system.

FIG. 9 is a diagram showing an example of information displayed on a serviceman terminal.

FIG. 10 is a diagram showing an example of information displayed on a serviceman terminal.

FIG. 11 is a flowchart showing an example of an operation of an image forming apparatus according to a second embodiment.

FIGS. 12A, 12B, 12C depict examples of information displayed on a serviceman terminal according to a modification example.

FIG. 13 is a diagram showing an example of information displayed on a serviceman terminal according to a modification example.

FIG. 14 is a diagram showing an example of information displayed on a serviceman terminal according to a modification example.

### DETAILED DESCRIPTION

Embodiments provide a server and an image forming apparatus that avoid replacement of a toner cartridge when a large amount of toner remains in the cartridge.

In general, according to one embodiment, a server for includes a processor and a communication printer systems interface connectable to an image forming apparatus and a user terminal. The processor is configured to receive, via the communication interface from the image forming apparatus, a first number indicating the number of standard sheets printable using an installed toner cartridge of a first type under a standard condition, a first average print ratio for the image forming apparatus for the installed toner cartridge based on a usage history of the image forming apparatus, a first average number of printed sheets per day for the image forming apparatus based on the usage history, and a first remaining amount indicating the amount of toner left in the installed toner cartridge. The processor is configured to calculate a number indicating the remaining number of sheets printable using the installed toner cartridge according to the first number, the first average print ratio, and the first remaining amount. The processor is also configured to calculate a number indicating the number of days for which the installed toner cartridge could be used before being empty according to the first number, the first average print ratio, the first average number of printed sheets per day, and the first remaining amount. The processor is further configured to transmit at least one of the calculated number indicating the remaining number of sheets printable using the installed toner cartridge or the calculated number of days for which the installed toner cartridge could be used before being empty via the communication interface to the user terminal.

Hereinafter, certain example embodiments will be described with reference to the drawings. In the description, constituent elements or aspects having substantially the same functions and configurations are represented by the same The following embodiments will illustrate reference symbols. certain technical ideas. The embodiments are not intended to limit the materials, shapes, structures, and arrangements, and the like of the various components. These embodiments can be modified in various ways.

### First Embodiment

### Configuration

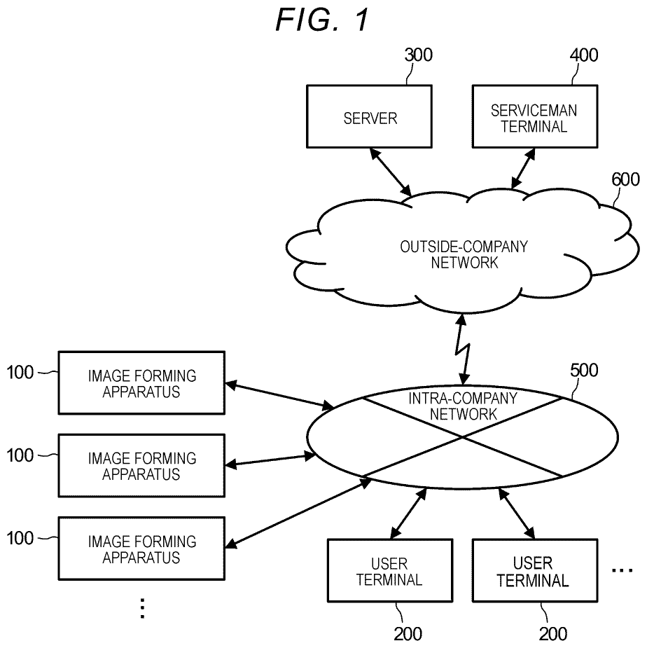

FIG. 1 depicts a printing system including a plurality of image forming apparatuses 100 according to a first embodiment. The printing system further includes a plurality of user terminals 200, a server 300, and a serviceman terminal 400. Each image forming apparatus 100 may be placed at a workplace, worksite, office, or the like and can be connected communicatively to, for example, the user terminal(s) 200 disposed at the same workplace or the like via an intra-company network 500, such as a local area network (LAN). The connection may be a wired connection or may be a wireless connection. The intra-company network 500 can also be connected to an outside-company network 600, such as the Internet. The server 300 and the serviceman terminal 400 are generally connected to the outside-company network 600. With this, each image forming apparatus 100 can be connected communicatively to the server 300 via the intra-company network 500 and the outside-company network 600.

The user terminal 200 is an information processing apparatus such as a personal computer (PC), a smartphone, a tablet terminal, or a digital camera that instructs printing by any of the image forming apparatuses 100. In some examples, a user terminal 200 may be connected communicatively to the image forming apparatus 100 via the outside-company network 600 and the intra-company network 500. That is, the user terminal 200 may be outside the workplace at which the image forming apparatus 100 is located. In some examples, the user terminal 200 may be connected directly, that is, locally, to an image forming apparatus 100 without use of the outside-company network 600 and the intra-company network 500. This local connection may be a wired connection or may be a wireless connection.

In this example, server 300 is a computer apparatus that is operated directly by a management company that has been contracted for maintenance and inspection of the image forming apparatuses 100 or is otherwise operated by a service provider. The server 300 acquires data indicating an operation status of each image forming apparatus 100 regularly or as deemed necessary. The server 300 functions to determine or estimate a need for inspection or repair of each image forming apparatus 100 based on acquired data. Then, if there is the image forming apparatus 100 that requires inspection or repair, the server 300 can send a serviceman for the inspection or repair of the image forming apparatus 100 by transmitting information to the serviceman terminal 400 that identifies the image forming apparatus 100.

The serviceman terminal 400 may be an information processing apparatus such as a smartphone or a tablet terminal carried by the serviceman. In FIG. 1, while only one serviceman terminal 400 is shown, the printing system can include a plurality of serviceman terminals 400. In this case, the server 300 can assign an appropriate serviceman to each image forming apparatus 100 that requires inspection or repair based on information regarding the availability of each serviceman.

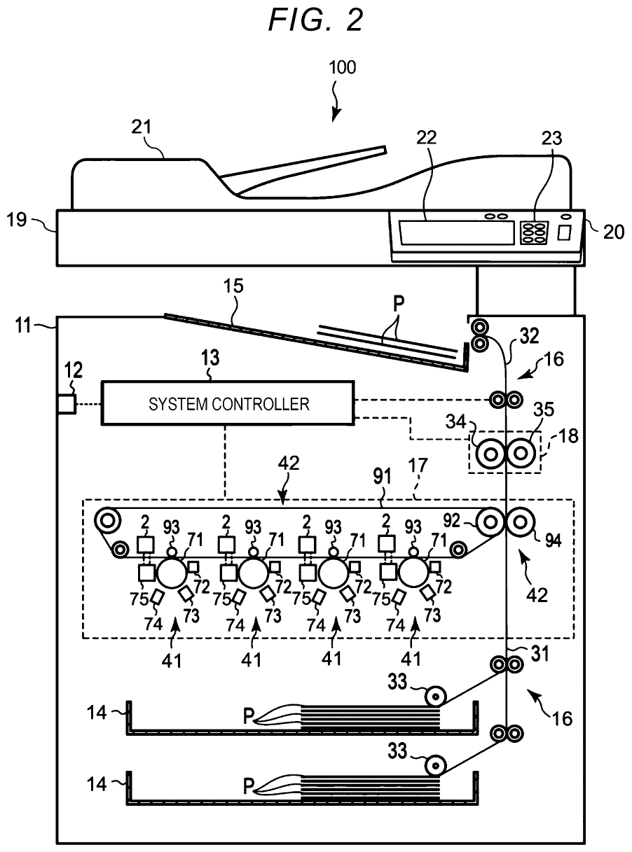

FIG. 2 shows an example of an image forming apparatus 100 according to the first embodiment.

The image forming apparatus 100 of this example performs printing using an electrophotographic method. The image forming apparatus 100 is, for example, a multifunction peripheral (MFP), a copying machine, a printer, or a facsimile machine.

The image forming apparatus 100 conveys a printing medium P and forms an image on the printing medium P by the electrophotographic method. The printing medium P is also referred to as a recording medium, a medium to be transferred, or a sheet. The image forming apparatus 100 is, for example, a multifunction peripheral (MFP) incorporating a copying machine, a printer, and a facsimile machine. FIG. 2 shows an image forming apparatus 100 that is an MFP. The image forming apparatus 100 receives toner from a toner cartridge 2, and forms an image on the printing medium P with the toner. Toner is, for example, toner of four colors of yellow (Y), magenta (M), cyan (C), and black (B). The combination of color toner is not limited thereto. Other colors may be provided or substituted. The image forming apparatus 100 may be a monochrome (single color) toner device. One or more of the toners may be special type toner. For example, one or more of the toners may be decolorable toner that can be decolored (becomes invisible or significantly so) by application of a temperature higher than some prescribed temperature.

As shown in FIG. 2, the image forming apparatus 100 includes a housing 11, a communication interface 12, a system controller 13, a plurality of sheet trays 14, a sheet discharge tray 15, a conveyance unit 16, an image forming unit 17, a fixing unit 18, a scanner unit 19, and a control panel 20.

The housing 11 is a main body of the image forming apparatus 100. The housing 11 accommodates the communication interface 12, the system controller 13, the plurality of sheet trays 14, the conveyance unit 16, the image forming unit 17, and the fixing unit 18. An upper surface of the housing 11 can be the sheet discharge tray 15.

The communication interface 12 is for communication with another apparatus connected via a network. The communication interface 12 is used for communication with an external apparatus. The external apparatus may be, for example, a user terminal 200 or server 300. The communication interface 12 comprises, for example, a LAN connector. The communication interface 12 may perform radio (RF) communication with another apparatus according to a standard such as Bluetooth or Wi-Fi.

The system controller 13 functions as a control unit of the image forming apparatus 100. The system controller 13 is connected to the communication interface 12. The system controller 13 generates a printing job based on printing data acquired from a user terminal 200 (or other an external apparatus) via the communication interface 12. In this context, a printing job includes image data indicating the image to be formed (printed) on the printing medium P. The image data may be data for forming an image on one printing medium P (a single sheet) or may be data for forming images on a plurality of printing mediums P (multiple sheets). The printing job may include information indicating whether color printing or monochrome printing is to be used.

The system controller 13 controls the operation of the conveyance unit 16, the image forming unit 17, and the fixing unit 18 to form an image on the printing medium P from the image data included in the printing job. Specifically, the system controller 13 controls conveyance of the printing medium P by the conveyance unit 16, image formation on the printing medium P by the image forming unit 17, and fixing of the image on the printing medium P by the fixing unit 18. In this way, the system controller 13 also has a function as an engine controller (printer engine) of the image forming apparatus 100.

The image forming apparatus 100 may include an engine controller separately from the system controller 13 in other examples. In such a case, the engine controller controls at least one of conveyance of the printing medium P by the conveyance unit 16, image formation on the printing medium P by the image forming unit 17, and fixing of the image on the printing medium P by the fixing unit 18. The system controller 13 supplies information necessary for control to the engine controller.

Each of the plurality of sheet trays 14 may be a cassette that stores printing media P. A sheet tray 14 can be configured such that the printing medium P can be supplied from the outside of the housing 11. For example, the sheet tray 14 is configured to be extractable from the housing 11.

The sheet discharge tray 15 receives the printing medium P discharged from the image forming apparatus 100.

The conveyance unit 16 is a mechanism that conveys the printing medium P in the image forming apparatus 100. As shown in FIG. 2, the conveyance unit 16 includes a plurality of conveyance paths. Specifically, the conveyance unit 16 includes a sheet feed conveyance path 31 and a sheet discharge conveyance path 32. The sheet feed conveyance path 31 and the sheet discharge conveyance path 32 are configured with a plurality of rollers, a plurality of guides, and the like. The rollers are rotated with power transmitted from a drive mechanism to convey the printing medium P. The guides control a conveyance direction of the printing medium P to be conveyed by the rollers.

Through the sheet feed conveyance path 31, the printing medium P is picked up from a sheet tray 14 and supplied to the image forming unit 17. The sheet feed conveyance path 31 includes a plurality of pick-up rollers 33 corresponding to the respective sheet trays 14. Each pick-up roller 33 picks up the printing medium P of the sheet tray 14 and supplies the printing medium P to the sheet feed conveyance path 31.

The sheet discharge conveyance path 32 is used to discharge, from the housing 11, the printing medium P on which an image has been formed by the image forming unit 17. The printing medium P discharged through the sheet discharge conveyance path 32 is supported by the sheet discharge tray 15.

The image forming unit 17 forms an image on the printing medium P.

The fixing unit 18 has a heat roller 34 and a pressing roller 35. The fixing unit 18 fixes the image transferred to the printing medium P onto the printing medium P by heating and pressing the printing medium P to a prescribed temperature using the heat roller 34 and the pressing roller 35.

The scanner unit 19 is a device that reads a document and converts the document into image data and is provided in an upper portion of the housing 11. The scanner unit 19 includes an automatic document feeder 21, and also supports reading of a document to be conveyed by the automatic document feeder 21.

The control panel 20 includes a touch panel 22, a keyboard 23, and the like. The touch panel 22 has, for example, a configuration in which a display such as a liquid crystal display or an organic EL display and a touch sensor are stacked. On the display, as information to be notified to a user of the image forming apparatus 100, a screen for setting various functions of the image forming apparatus 100, indicating a remaining amount of toner, or the like can be displayed.

The keyboard 23 includes various keys that are operated by the user of the image forming apparatus 100. For example, the keyboard 23 may include a numeric keypad, a power key, a sheet feed key, and a function key. Each key may also be referred to as a button. The touch panel 22 and the keyboard 23 together function as an input device of the image forming apparatus 100. The display in the touch panel 22 may also function as a display device of the image forming apparatus 100.

Next, the image forming unit 17 will be described.

As shown in FIG. 2, the image forming unit 17 includes a transfer unit 42 and a plurality of process units 41. Each process unit 41 is a unit that forms a toner image. A separate process unit 41 is provided for each kind of toner. For example, the process units 41 correspond to color toners for yellow, magenta, cyan, and black starting from the left side in FIG. 2, respectively. Each process unit 41 includes a toner cartridge 2 with the corresponding color toner.

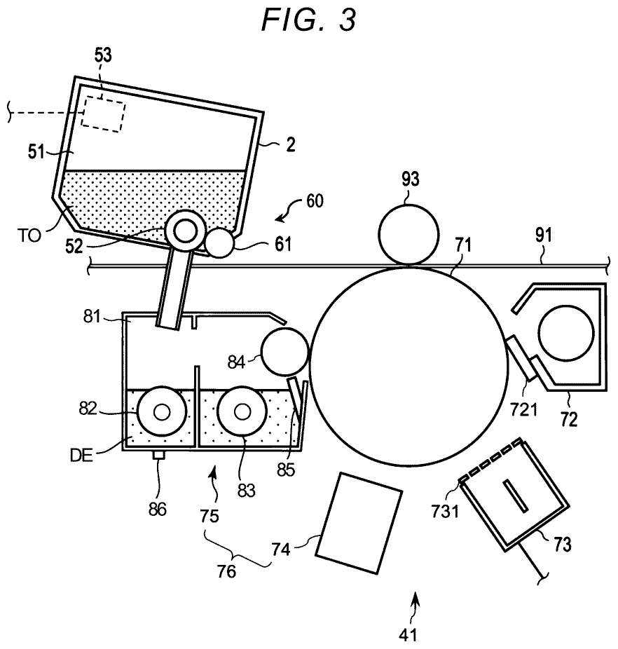

FIG. 3 is a schematic view of an image forming unit 17 of the image forming apparatus 100 according to the first embodiment. Each of the toner cartridges 2 and the process units 41 has the same configuration in this example. Accordingly, in FIG. 3, one toner cartridge 2 and one process unit 41 are given as representative.

First, the toner cartridge 2 will be described. As shown in FIG. 3, the toner cartridge 2 includes a toner container 51, a toner delivery mechanism 52, and a memory 53.

The toner container 51 is a container that holds the toner. The toner delivery mechanism 52 is a mechanism that delivers the toner from the toner container 51 for printing. The toner delivery mechanism 52 is, for example, a screw provided inside the toner container 51. With the rotation of the screw, the toner in the toner container 51 is delivered for printing purposes.

The toner container 51 is mounted in a mounting unit 60. The mounting unit 60 is a module to which the toner cartridge 2 (filled with toner) can be mounted or attached. The mounting unit 60 includes a toner supply motor 61. The mounting unit 60 also includes a connector that connects the memory 53 of the toner cartridge 2 to the system controller 13.

When the toner cartridge 2 is mounted on the mounting unit 60, the toner supply motor 61 is connected to the toner delivery mechanism 52 of the toner cartridge 2. The toner supply motor 61 drives the toner delivery mechanism 52 under the control of the system controller 13. The toner supply motor 61 drives the toner delivery mechanism 52, so that the toner in the toner container 51 will be supplied to a developing unit 75. Information regarding the number of times toner has been supplied to the developing unit 75 by the driving of the toner delivery mechanism 52, date and time on which toner was supplied, and the like may be stored in the memory 53 of the toner cartridge 2.

Next, the process unit 41 will be described. As shown in FIG. 3, the process unit 41 includes a photosensitive drum 71, a cleaner 72, a charging unit 73, an exposure head 74, and the developing unit 75.

The photosensitive drum 71 is a photoreceptor comprising a cylindrical drum and a photosensitive layer formed on an outer peripheral surface of the drum. The photosensitive drum 71 rotates at a given speed with power transmitted from a drive mechanism. The photosensitive drum 71 is an example of an image carrier.

The cleaner 72 has a blade 721 that is in contact with a surface of the photosensitive drum 71. The cleaner 72 removes toner from the surface of the photosensitive drum 71 using the blade 721.

The charging unit 73 is a device that uniformly charges the surface of the photosensitive drum 71. For example, the charging unit 73 charges the photosensitive drum 71 to a uniform negative potential by applying a grid bias voltage output from a grid electrode 731 to the photosensitive drum 71. The charging unit 73 is also referred to as a charging charger.

The exposure head 74 includes a plurality of light emitting elements. The light emitting element is, for example, a laser diode (LD), a light emitting diode (LED), or an organic EL (OLED). The plurality of light emitting elements are arranged in a main scanning direction that is a direction parallel to a rotation axis of the photosensitive drum 71. Then, each light emitting element is configured to irradiate one point on the photosensitive drum 71 with light.

The exposure head 74 forms a latent image for one line on the photosensitive drum 71 by irradiating the surface of the charged photosensitive drum 71 with light from the plurality of light emitting elements arranged in the main scanning direction. In addition, the exposure head 74 forms a latent image covering a plurality of lines by irradiating the rotating photosensitive drum 71 with light.

The developing unit 75 is a device that attaches toner to the photosensitive drum 71 to form a toner image on the photosensitive drum. The developing unit 75 includes a developer container 81, a stirring-side mixer 82, a developing roller-side mixer 83, a developing roller 84, a doctor blade 85, an automatic toner control (ATC) sensor 86, and the like.

The developer container 81 is a container that holds a developer comprising toner particles and carrier particles. The developer container 81 receives toner delivered from the toner cartridge 2 by the toner delivery mechanism 52. The carrier is placed in the developer container 81 when the developing unit 75 is manufactured.

The stirring-side mixer 82 and the developing roller-side mixer 83 are in the developer container 81. The stirring-side mixer 82 and the developing roller-side mixer 83 stir the toner and the carrier in the developer container 81 as a stirring mechanism.

The developing roller 84 attaches the developer to the surface of the roller by rotating in the developer container 81.

The doctor blade 85 is a member disposed at a prescribed distance from the surface of the developing roller 84. The doctor blade 85 removes an excess part of the developer attached to the surface of the rotating developing roller 84. With this, a uniform layer of developer at a thickness matching the distance between the doctor blade 85 and the surface of the developing roller 84 is formed on the surface of the developing roller 84.

The ATC sensor 86 has, for example, a coil and detects a voltage value generated in the coil. The detected voltage of the ATC sensor 86 changes depending on density of magnetic flux from the toner in the developer container 81. That is, the ATC sensor 86 detects a voltage according to a toner concentration in the developer container 81. The system controller 13 can determine the toner concentration in the developer container 81 based on the detected voltage of the ATC sensor 86.

As described above, when the surface of the photosensitive drum 71 charged by the charging unit 73 is irradiated with light from the exposure head 74, a latent image is formed. Thereafter, when the layer of the developer formed on the surface of the developing roller 84 in the developing unit 75 approaches the surface of the photosensitive drum 71, toner in the developer is attached to the latent image formed on the surface of the photosensitive drum 71. With this, a toner image is formed on the surface of the photosensitive drum 71. That is, the exposure head 74 and the developing unit 75 configure an image formation unit 76.

The transfer unit 42 is configured to transfer the toner image formed on the surface of the photosensitive drum 71 to the printing medium P. As shown in FIGS. 2 and 3, the transfer unit 42 includes a transfer belt 91, a secondary transfer counter roller 92, a plurality of primary transfer rollers 93, and a secondary transfer roller 94.

The transfer belt 91 is an endless belt wound around the secondary transfer counter roller 92 and a plurality of winding rollers. A rear surface of the transfer belt 91, which is an inner surface, comes into contact with the secondary transfer counter roller 92 and the plurality of winding rollers, and a surface of the transfer belt 91 faces the photosensitive drum 71 of the process unit 41.

The secondary transfer counter roller 92 conveys the transfer belt 91 by rotating with power transmitted from a drive mechanism. The secondary transfer counter roller 92 rotates in a counterclockwise direction in FIG. 2. With the rotation, the transfer belt 91 is conveyed to rotate in the counterclockwise direction in FIG. 2. The winding rollers are configured to be freely rotatable. The winding rollers rotate with the movement of the transfer belt 91 by the secondary transfer counter roller 92.

The primary transfer rollers 93 are provided for each process unit 41. Each of the primary transfer rollers 93 is provided to face the photosensitive drum 71 of the corresponding process unit 41. Specifically, a primary transfer roller 93 is provided at a position facing the photosensitive drum 71 of the corresponding process unit 41 with the transfer belt 91 interposed therebetween. The primary transfer roller 93 is in contact with an inner peripheral surface side of the transfer belt 91 and displaces the transfer belt 91 towards the photosensitive drum 71 side. With the displacement, the surface of the transfer belt 91 comes into contact with the photosensitive drum 71.

The secondary transfer roller 94 is provided at a position facing the secondary transfer counter roller 92. The secondary transfer roller 94 is in contact with the surface of the transfer belt 91 conveyed on a peripheral surface of the secondary transfer counter roller 92 and applies pressure. With the contact and the pressure, a transfer nip is formed by contact between the secondary transfer roller 94 and the transfer belt 91.

The secondary transfer roller 94 and the secondary transfer counter roller 92 rotate to convey the printing medium P sandwiched between the secondary transfer roller 94 and the secondary transfer counter roller 92. As a result, the printing medium P passes through the transfer nip. The secondary transfer roller 94 presses the printing medium P against the surface of the transfer belt 91 as it passes through the transfer nip.

In the transfer unit 42 having the above-described configuration, when the surface of the transfer belt 91 comes into contact with the photosensitive drum 71, the toner image formed on the surface of the photosensitive drum 71 is transferred (primary transfer) to the surface of the transfer belt 91. As shown in FIG. 2, if the image forming unit 17 includes a plurality of process units 41, toner images are transferred from the photosensitive drums 71 of each of the plurality of process units 41 to the transfer belt 91. The toner image transferred to the surface of the transfer belt 91 is conveyed to the transfer nip by the transfer belt 91. In this case, if the printing medium P is present in the transfer nip, the toner image is transferred (secondary transfer) to the printing medium P in the transfer nip.

Next, a hardware configuration of the image forming apparatus 100 will be described.

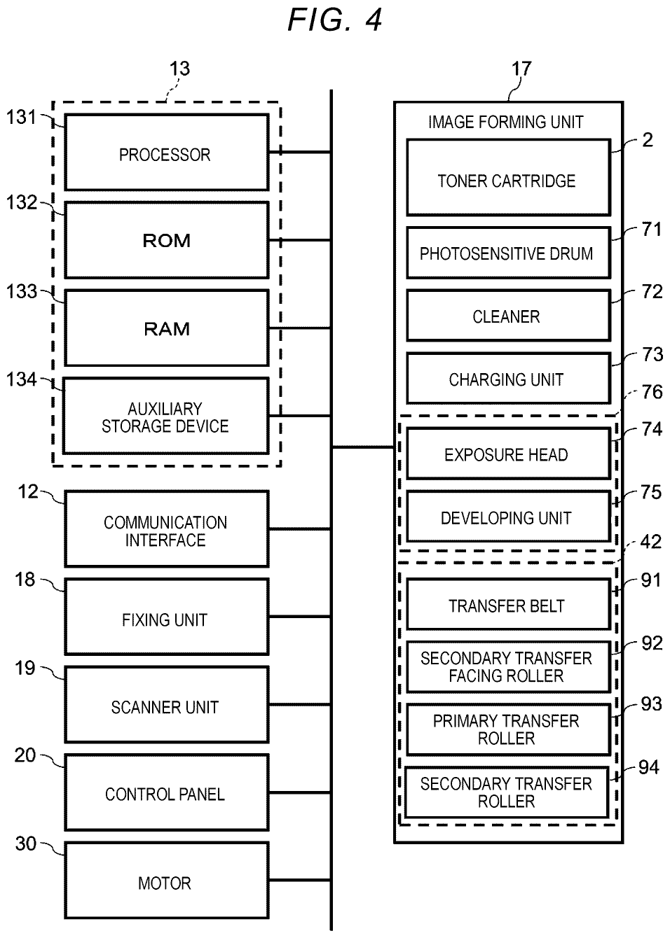

FIG. 4 is a block diagram showing an example of the image forming apparatus 100 according to the first embodiment. As shown, the image forming apparatus 100 comprises the communication interface 12, the image forming unit 17, the fixing unit 18, the scanner unit 19, the control panel 20, the motor 30, and the like, which are connected to the system controller 13 by signal lines or the like.

The system controller 13 includes a processor 131, a read only memory (ROM) 132, a random access memory (RAM) 133, and an auxiliary storage device 134. The system controller 13 comprises the processor 131, the ROM 132, the RAM 133, and the auxiliary storage device 134.

The processor 131 is equivalent to a central portion of a computer or the like. The processor 131 controls each unit to implement various functions as the image forming apparatus 100 according to an operating system and/or application programs. The processor 131 is, for example, a central processing unit (CPU). The processor 131 may be, for example, a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 131 may be a combination of these devices.

The ROM 132 is a non-volatile memory area, and the RAM 133 is a volatile memory area. The ROM 132 can also be called a non-transitory computer-readable storage medium. The ROM 132 stores the operating system or the application programs. The ROM 132 stores data necessary for the processor 131 to execute processing for controlling each unit. The RAM 133 is used as a work area where data is rewritten as appropriate by the processor 131.

The auxiliary storage device 134 is a non-transitory computer-readable storage medium. As the auxiliary storage device 134, for example, any known storage device such as an electric erasable programmable read-only memory (EEPROM), a hard disc drive (HDD), or a solid-state drive (SSD) can be used alone or in combination. The auxiliary storage device 134 stores data used by the processor 131 in executing various kinds of processing or data generated by the processing of the processor 131. The auxiliary storage device 134 may store application programs.

The image forming apparatus 100 may include an interface into which a non-transitory computer-readable storage medium such as a removable optical disc, a memory card, or a universal serial bus (USB) memory can be inserted, instead of the auxiliary storage device 134 or in addition to the auxiliary storage device 134.

The application programs stored in the ROM 132 or the auxiliary storage device 134 include a program for executing processing described below. As an example, the image forming apparatus 100 may be transferred to an administrator, end user, or the like with the program already stored in the ROM 132 or the auxiliary storage device 134. Alternatively, the image forming apparatus 100 may be transferred without the program stored in the ROM 132 or the auxiliary storage device 134. Then, the program may be separately transferred, and may then be written to the ROM 132 or the auxiliary storage device 134 based on an operation by the administrator, a serviceman, or the like. The transfer of the program in this case can be implemented, for example, by recording the program in a removable non-transitory computer-readable storage medium such as a magnetic disk, a magneto-optical disk, an optical disc, or a semiconductor memory, or by downloading the program via the network or the like.

The system controller 13 connects to the toner cartridge 2, the photosensitive drum 71, the cleaner 72, the charging unit 73, the image formation unit (exposure head 74, developing unit 75 (ATC sensor 86)) 76, the transfer unit 42 (including transfer belt 91, secondary transfer counter roller 92, primary transfer roller 93, and secondary transfer roller 94) of the image forming signal lines. The system controller 13 controls each of the toner cartridge 2, the photosensitive drum 71, the cleaner 72, the charging unit 73, and the image formation unit 76 provided for the process unit 41, the transfer unit 42, and the fixing unit 18 to form an image on the printing medium P.

The motor 30 may comprise a first motor that is used in the drive mechanism configured to drive the conveyance unit 16, a second motor that is used in the drive mechanism configured to rotate the photosensitive drum 71, and a third motor that is used in the drive mechanism configured to rotate the secondary transfer counter roller 92. A plurality of second motors may be provided corresponding to the photosensitive drums 71 that are provided in the plurality of process unit 41, respectively. The motor 30 may comprise a motor that is used in a drive mechanism other than the drive mechanisms described above. The motor 30 is, for example, a brushless motor. The motor 30 may be a brush motor.

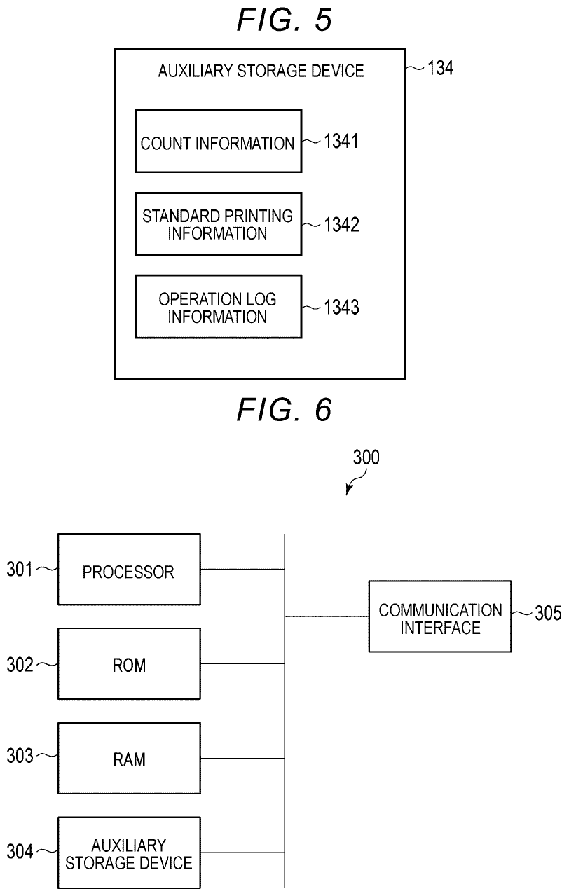

FIG. 5 is a conceptual diagram showing data stored in the auxiliary storage device of the image forming apparatus according to the first embodiment. As shown in FIG. 5, count information 1341, standard printing information 1342, and operation log information 1343 are stored in the auxiliary storage device 134.

In the count information 1341, a relationship between a drive count value of the toner supply motor 61 and a remaining amount of toner in the toner cartridge 2 is stored. That is, the processor 131 can obtain or estimate the remaining amount of toner in a toner cartridge 2 based on the drive count value of the toner supply motor 61 and the count information 1341.

In the standard printing information 1342, the number of sheets that can be printed before the toner cartridge 2 becomes empty when printing is performed at a standard print ratio using each type of the toner cartridge 2 is stored in association with the types of toner cartridges 2 that can be mounted in the image forming apparatus 100.

In the operation log information 1343, information regarding an operation status of the image forming apparatus 100 is stored. Information that is stored in the operation log information 1343 includes, for example, an average print ratio for each toner cartridge 2, the average number of printed sheets per day, and date and time on which the toner cartridge 2 was previously replaced or installed.

FIG. 6 is a block diagram showing a configuration example of the server according to the first embodiment. As shown in FIG. 6, the server 300 comprises a ROM 302, a RAM 303, an auxiliary storage device 304, and a communication interface 305 connected to processor 301.

The server 300 is a computer.

The processor 301 is equivalent to a central portion of a computer. The processor 301 controls each unit to implement various functions as the server 300 according to an operating system and/or application programs. The processor 301 is, for example, a CPU. The processor 301 may be, for example, a MPU, a SoC, a DSP, a GPU, an ASIC, a PLD, or an FPGA. Alternatively, the processor 301 may be a combination of these devices.

The ROM 302 is a non-volatile memory area, and the RAM 303 is a volatile memory area. The ROM 302 can also be called a non-transitory computer-readable storage medium. The ROM 302 stores the operating system or the application programs. The ROM 302 stores data necessary for the processor 301 to execute processing for controlling each unit. The RAM 303 is used as a work area where data is rewritten as appropriate by the processor 301.

The auxiliary storage device 304 is a non-transitory computer-readable storage medium. As the auxiliary storage device 304, for example, a known storage device such as an EEPROM, an HDD, or an SSD is used alone or in combination. The auxiliary storage device 304 stores data used by the processor 301 in executing various kinds of processing, or data generated by the processing in the processor 301. The auxiliary storage device 304 may store application programs.

The server 300 may include an interface into which a non-transitory computer-readable storage medium such as a removable optical disc, a memory card, or a USB memory can be inserted, instead of the auxiliary storage device 304 or in addition to the auxiliary storage device 304.

The application programs stored in the ROM 302 or the auxiliary storage device 304 include a program for executing processing described below. As an example, the server 300 may be transferred to an administrator or the like of the server 300 with the program stored in the ROM 302 or the auxiliary storage device 304. Alternatively, the server 300 may be transferred without the program being stored in the ROM 302 or the auxiliary storage device 304. Then, the program may be separately transferred and written to the ROM 302 or the auxiliary storage device 304 based on an operation by the administrator, a serviceman, or the like. The transfer of the program in this case can be implemented, for example, by recording the program in a removable non-transitory computer-readable storage medium such as a magnetic disk, a magneto-optical disk, an optical disc or a semiconductor memory, or by downloading the program via the network or the like.

The communication interface 305 is for communication with another apparatus connected via the network. The communication interface 305 is used for communicating with an external apparatus. The external apparatus may be, for example, the image forming apparatus 100, the user terminal 200, or the serviceman terminal 400. The communication interface 305 comprises, for example, a LAN connector. The communication interface 305 may perform radio communication with another apparatus according to a standard such as Bluetooth or Wi-Fi.

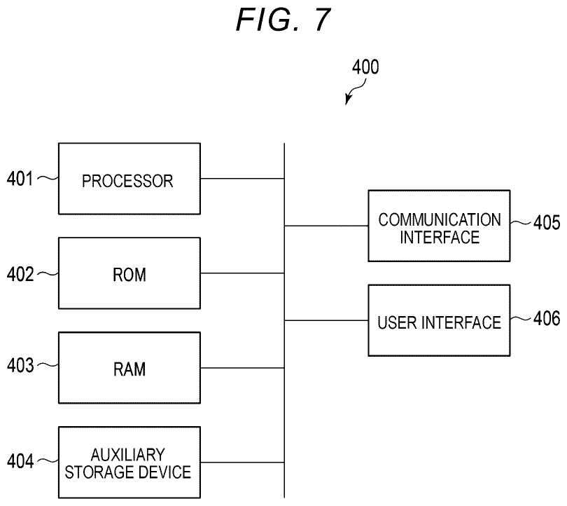

FIG. 7 is a block diagram showing a configuration example of the serviceman terminal according to the first embodiment. As shown in FIG. 7, the serviceman terminal 400 comprises a ROM 402, a RAM 403, an auxiliary storage device 404, a communication interface 405, and a user interface 406 connected to a processor 401 by signal lines.

The serviceman terminal 400 is a computer.

The processor 401 is equivalent to a central portion of a computer. The processor 401 controls each unit to implement various functions as the serviceman terminal 400 according to an operating system and/or application programs. The processor 401 is, for example, a CPU. The processor 401 may be, for example, a MPU, a SoC, a DSP, a GPU, an ASIC, a PLD, or an FPGA. Alternatively, the processor 401 may be a combination of these devices.

The ROM 402 is a non-volatile memory area, and the RAM 403 is a volatile memory area. The ROM 402 can also be called a non-transitory computer-readable storage medium. The ROM 402 stores an operating system or application programs. The ROM 402 stores data necessary for the processor 401 to execute processing for controlling each unit. The RAM 403 is used as a work area where data is rewritten as appropriate by the processor 401.

The auxiliary storage device 404 is a non-transitory computer-readable storage medium, and is equivalent to an auxiliary storage portion of the computer. As the auxiliary storage device 404, a known storage device such as an EEPROM, an HDD, or an SSD is used alone or in combination. The auxiliary storage device 404 stores data used by the processor 401 in executing various kinds of processing or data generated by the processing in the processor 401. The auxiliary storage device 404 may store application programs.

The serviceman terminal 400 may include an interface into which a non-transitory computer-readable storage medium such as a removable optical disc, a memory card, or a USB memory can be inserted, instead of the auxiliary storage device 404 or in addition to the auxiliary storage device 404.

The application programs stored in the ROM 402 or the auxiliary storage device 404 include a program for executing processing described below. As an example, the serviceman terminal 400 may be transferred to an administrator or the like with the program stored in the ROM 402 or the auxiliary storage device 404. Alternatively, the serviceman terminal 400 may be transferred without the program stored in the ROM 402 or the auxiliary storage device 404. Then, the program may be separately transferred to the administrator or the like, and may be written to the ROM 402 or the auxiliary storage device 404 based on an operation by the administrator, a serviceman, or the like. The transfer of the program in this case can be implemented, for example, by recording the program in a removable non-transitory computer-readable storage medium such as a magnetic disk, a magneto-optical disk, an optical disc or a semiconductor memory, or by downloading the program via the network or the like.

The communication interface 405 is for communication with another apparatus via the network. The communication interface 405 is used for communicating with an external apparatus. The external apparatus includes, for example, the image forming apparatus 100, the user terminal 200, or the server 300. The communication interface 405 comprises, for example, a LAN connector. The communication interface 405 may perform radio communication with another apparatus according to a standard such as Bluetooth or Wi-Fi.

The user interface 406 provides information to a user and receives an input from the user. The user interface 406 is, for example, a touch panel display. The user interface 406 may include a display, a keyboard, and a mouse.

### Operation

An operation of each unit of the printing system according to the first embodiment will be described. In the following description, while the kind of the toner cartridge 2 is not particularly stated, if the image forming apparatus 100 accommodates plurality of kinds of toner cartridges 2, the operation or similar thereto would be performed for each. Specifically, in the present embodiment, for each of four toner cartridges 2 (yellow, magenta, cyan, and black), the following operation is performed. If a toner cartridge 2 accommodated in the image forming apparatus 100 is replaced, for each of the previously accommodated toner cartridge 2 and the newly accommodated toner cartridge 2, the following operation can be performed.

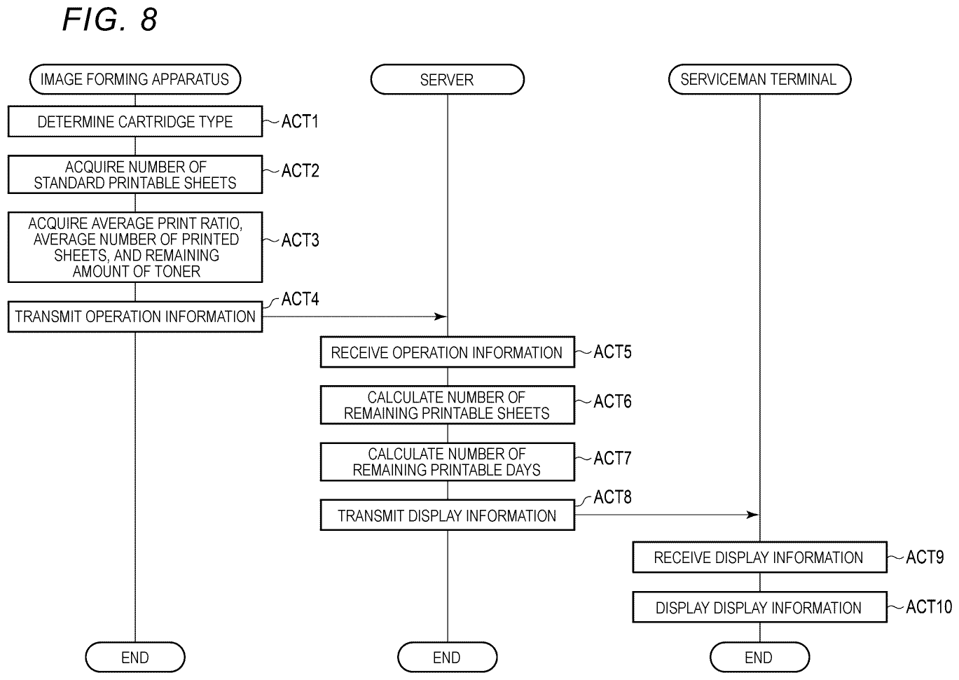

FIG. 8 is a sequence diagram showing an example of the operation of a printing system according to the first embodiment. The image forming apparatus 100 determines a cartridge type of an installed toner cartridge 2 (ACT1). The processor 131 of the image forming apparatus 100 in this example reads out cartridge information from the memory 53 of the toner cartridge 2 and thus determines the cartridge type.

The image forming apparatus 100 acquires the number of standard printable sheets (ACT2). The processor 131, for example, reads out the standard printing information 1342 from the auxiliary storage device 134 and acquires a standard print ratio and the number of standard printable sheets based on the cartridge type determined in ACT1.

The image forming apparatus 100 also acquires an average print ratio, the average number of printed sheets per day or the like, and a remaining amount of toner (ACT3). The processor 131 can acquire the average print ratio and the average number of printed sheets per day from the operation log information 1343 stored in the auxiliary storage device 134. The processor 131 in this example acquires the remaining amount of toner in the toner cartridge 3 from the drive count value for the toner supply motor 61 and the count information 1341 stored in the auxiliary storage device 134. After this information is acquired for the detached toner cartridge 2, the drive count value of the toner supply motor 61 acquired since installation can be used.

The image forming apparatus 100 transmits operation information to the server 300 (ACT4). The processor 131 controls the communication interface 12 to transmit the standard print ratio, the number of standard printable sheets, the average print ratio, the average number of printed sheets, and the remaining amount of toner to the server 300. The processor 131 may transmit other kinds of information, such as a date on which the toner cartridge 2 was last replaced to the server 300, in addition to the above-described information.

The server 300 receives the operation information (ACT5). The processor 301 of the server 300 controls the communication interface 305 to receive the operation information sent from the image forming apparatus 100.

The server 300 calculates or estimates the number of remaining printable sheets (ACT6). The processor 301, for examples, calculates the number of remaining printable sheets (the number of sheets that can be printed before the toner cartridge 2 is empty) from a previous use status of the image forming apparatus 100 using the standard print ratio, the number of standard printable sheets, the average print ratio, and the remaining amount of toner. In a calculation for a detached toner cartridge 2, the number of remaining printable sheets may be calculated as the number of sheets estimated to be printable if the toner cartridge 2 was not detached. As an example calculation (estimation) method, when the standard print ratio is taken as a value a (%), the number of standard printable sheets as a value b (sheets), the average print ratio as a value c (%), the remaining amount of toner as a value d (%), and the number of remaining printable sheets is a value A (sheets), the following equation can be adopted:

A=b×(a/c)×(d/100)

That is, the number of remaining printable sheets (A) is calculated by multiplying the number of standard printable sheets (b) by the standard print ratio (a) divided by the average print ratio and multiplying the result by the remaining amount of toner (expressed as a decimal number).

The server 300 may then calculate (estimate) the number of remaining printable days (ACT7). The processor 301 divides the number of remaining printable sheets by the average number of printed sheets per day (or the like) to calculate the number of remaining printable days, which is the number of days for which printing can be expected to be performed until the toner cartridge 2 becomes empty. The average number of printed sheets per day may be estimated from a previous use history of the image forming apparatus 100 or the like. In calculation for a detached toner cartridge 2, the number of remaining printable days is calculated as the number of days estimated that printing can be performed if the toner cartridge 2 was not detached. As the average number of printed sheets used in calculation, a sum of the number of sheets printed by black and white printing and the number of sheets printed by color printing may be used separately in calculation for a black toner cartridge 2 of black, and color toner cartridges 2 (e.g., for yellow, magenta, and cyan toner cartridges 2).

The server 300 then transmits display information (ACT8). The processor 301 controls the communication interface 305 to transmit display information including at least the number of remaining printable sheets or the number of remaining printable days to the serviceman terminal 400.

The serviceman terminal 400 receives the display information (ACT9). The processor 401 of the serviceman terminal 400 controls the communication interface 405 to receive the display information including at least the number of remaining printable sheets or the number of remaining printable days from the server 300.

The serviceman terminal 400 displays the display information (ACT10). The processor 401 controls the user interface 406 to display the display information to the user of the serviceman terminal 400.

Once the processing of ACT10 is completed, the series of processing shown in FIG. 8 ends.

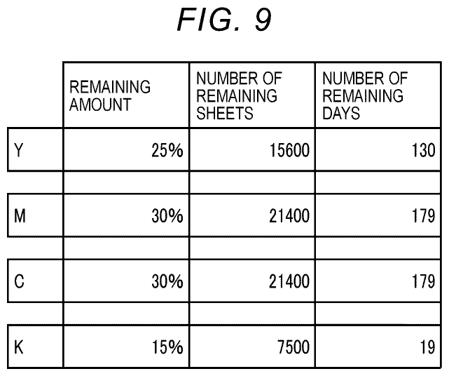

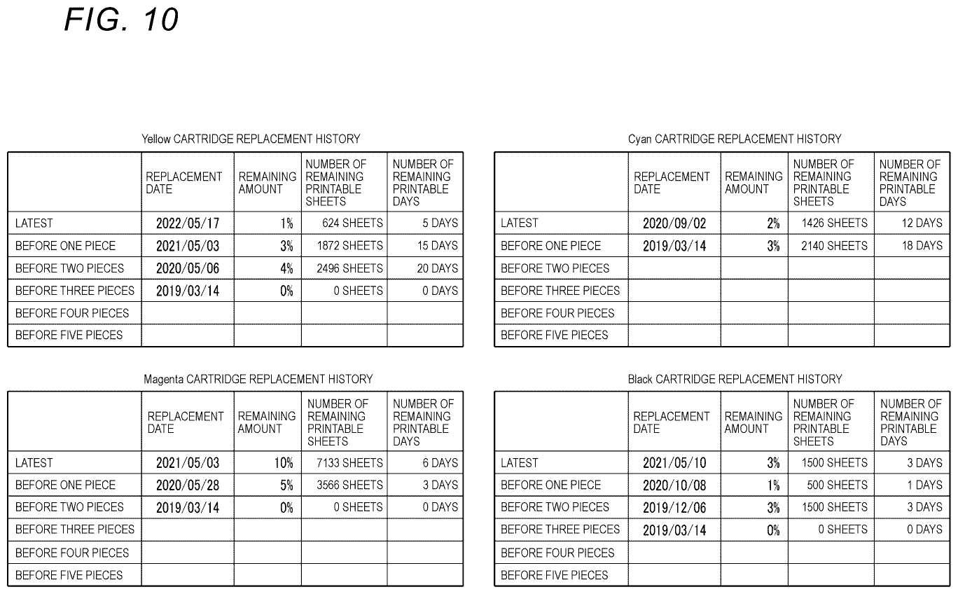

FIGS. 9 and 10 are diagrams showing an example of information that is displayed on the serviceman terminal according to the first embodiment. In FIGS. 9 and 10, information is displayed for each of a plurality of toner cartridges 2 that respectively contain one of four colors: yellow (Y), magenta (M), cyan (C), and black (K). In FIG. 9, for each of the toner cartridges 2 currently mounted in an image forming apparatus 100, the remaining amount of toner is displayed in a field of “remaining amount,” the number of remaining printable sheets is displayed in a field of “number of remaining sheets,” and the number of remaining printable days is displayed in a field of “number of remaining days.”

In FIG. 10, for the toner cartridges 2 previously detached from the image forming apparatus 100, a date on which the toner cartridge 2 was detached is displayed in a field of “replacement date,” the remaining amount of toner when the toner cartridge 2 was detached is displayed in a field of “remaining amount,” the number of remaining printable sheets is displayed in a field of “number of remaining printable sheets,” and the number of remaining printable days is displayed in a field of “number of remaining printable days.”

### Effects

In this way, according to the first embodiment, the use status of a toner cartridge 2 in the image forming apparatus 100 is transmitted to the server 300 when replaced. Then, the number of remaining printable sheets and the number of remaining printable days are calculated in the server 300, and are transmitted from the server 300 to the serviceman terminal 400. Then, in the serviceman terminal 400, the received information is displayed. Accordingly, the user of the serviceman terminal 400, that is, a serviceman can know or estimate the number of remaining printable sheets and the number of remaining printable days of toner cartridges 2.

In the operation of the image forming apparatus 100, if a new toner cartridge 2 is available for replacement before an already installed toner cartridge 2 is empty, the installed toner cartridge 2 may be replaced with the new toner cartridge 2 in some circumstances. The remaining amount of toner in the replaced toner cartridge 2 cannot be used for printing and is thus wasted and this causes an increase in effective printing costs in this regard. When the remaining amount of toner in an installed toner cartridge is merely displayed as a percent of full and it is considered that it is difficult to intuitively understand how much toner usage is left given differences in consumption rates amongst different printers and/or even toner types. For this reason, it is considered difficult to understand how much is wasted when a toner cartridge 2 is replaced before becoming completely empty.

According to the first embodiment, the serviceman can see a calculated (estimated) number of remaining printable sheets and number of remaining printable days of a toner cartridge 2. The number of remaining printable sheets and the number of remaining printable days can be calculated based on an actual use status (history) of the image forming apparatus 100 of concern, since toner usage may vary significantly apparatus to apparatus. The number of remaining printable sheets and the number of remaining printable days are specific values unlike the percent full allowing a user to more easily understand, intuitively, what is being given up by replacement of a partially full toner cartridge 2. The serviceman may report the number of remaining printable sheets and the number of remaining printable days to a person operating the image forming apparatus 100 to specifically report how much toner will be or has been wasted. With this, according to the first embodiment, it is possible to prevent replacement of a toner cartridge 2 when a lot of toner usage (expressed as number of sheets or days) is still left.

According to the first embodiment, for each toner cartridge 2 replaced in the past at the image forming apparatus 100, it is possible to know the number of remaining printable sheets and the number of remaining printable days that were given up by the replacement process. With this, according to the first embodiment, the replacement status of toner cartridges 2 used in the past in a printing system as well as the use history of a specific toner cartridge 2 can be known.

According to the first embodiment, the number of remaining printable sheets is calculated by multiplying the number of standard printable sheets by the standard print ratio, dividing the number of standard printable sheets by the average print ratio, and multiplying the number of standard printable sheets by the ratio of the remaining amount of toner. With this, according to the first embodiment, even when printing is typically performed (locally) at a print ratio different from the standard print ratio, a more specific or accurate number of remaining printable sheets based on the local use history can be calculated.

According to the first embodiment, with the display of the serviceman terminal 400, the date on which the toner cartridge 2 was replaced in the past can be known. With this, according to the first embodiment, it is also possible to guess a next replacement date from the interval to the last replacement date, and to improve convenience by switching out a toner cartridge 2 that might otherwise run out before the next scheduled or available maintenance event.

According to the first embodiment, for the toner cartridge 2 accommodated at present as well as the toner cartridge 2 detached in the past, the number of remaining printable sheets and the number of remaining printable days can be known. With this, according to the first embodiment, it is possible to provide a toner cartridge 2 for replacement at an appropriate timing.

### Second Embodiment

A printing system according to a second embodiment will be described. The printing system according to the second embodiment is different from the printing system according to the first embodiment in that the calculation and the display of the number of remaining printable sheets and the number of remaining printable days are performed by each image forming apparatus 100. Hereinafter, the printing system according to the second embodiment will be described focusing on differences from the first embodiment.

### Configuration

The configuration of the printing system according to the second embodiment is similar to the configuration of the printing system according to the first embodiment.

### Operation

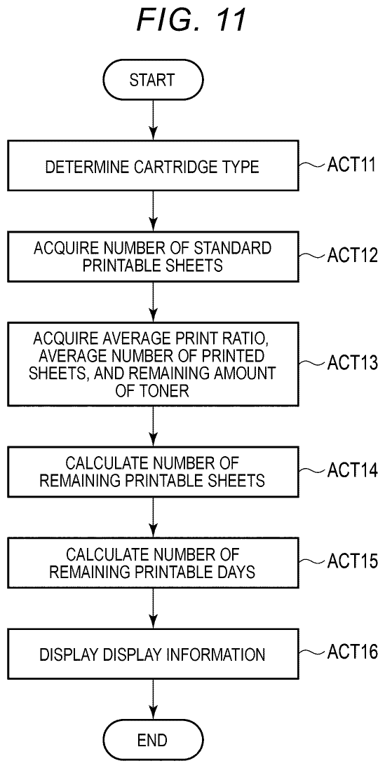

The operation of the printing system according to the second embodiment is different from the operation of the printing system according to the first embodiment in that the calculation and the display of the number of remaining printable sheets and the number of remaining printable days are performed by an image forming apparatus 100. Hereinafter, the operation of the image forming apparatus 100 according to the second embodiment will be described with reference to FIG. 11.

FIG. 11 is a flowchart showing an example of the operation of the image forming apparatus 100 according to the second embodiment. The image forming apparatus 100 determines the cartridge type of an installed toner cartridge 2 (ACT11). The image forming apparatus 100 acquires the number of standard printable sheets (ACT12). The image forming apparatus 100 acquires the average print ratio, the average number of printed sheets per day or the like, and the remaining amount of toner (ACT13). The operation of ACT11 to ACT13 are, in general, similar to ACT1 to ACT3 described above with reference to FIG. 8 in the first embodiment.

The image forming apparatus 100 next calculates the number of remaining printable sheets (ACT14). The processor 131 f the image forming apparatus 100 calculates the number of remaining printable sheets, which is the estimated number of sheets that could be printed before the toner cartridge 2 becomes empty based on the previous use status (history) of the image forming apparatus 100. The estimation uses the standard print ratio, the number of standard printable sheets, the average print ratio, and the remaining amount of toner. In calculation for a removed (de-installed) toner cartridge 2, the number of remaining printable sheets is calculated as the number of sheets that could have been printed if the toner cartridge 2 was not removed. A calculation method in this context is similar to ACT6 described with reference to FIG. 8 in the first embodiment.

The image forming apparatus 100 calculates (estimates) the number of remaining printable days (ACT15). The processor 131, for example, divides the number of remaining printable sheets by the average number of printed sheets per day to calculate the number of remaining printable days, which is the number of days on which normal (average) printing operations can be performed until the toner cartridge 2 becomes empty, as estimated from the previous use history of the image forming apparatus 100. In a calculation for a removed toner cartridge 2, the number of remaining printable days is calculated as the number of days for which (average) printing could be performed if the toner cartridge 2 was not removed. As the average number of printed sheets used in calculation, the number of sheets printed by black and white printing or the number of sheets printed by color printing may be used as appropriate to the toner cartridge 2 type(s).

The image forming apparatus 100 displays the display information (ACT16). The processor 131 controls the control panel 20 to display the display information including the number of remaining printable sheets and the number of remaining printable days to the user of the image forming apparatus 100.

After the processing of ACT16 is completed, the series of processing shown in FIG. 11 ends.

Information displayed on the control panel 20 is, in general, similar to information shown in FIGS. 9 and 10 described in the first embodiment.

### Effects

In this way, according to the second embodiment, in the image forming apparatus 100, the number of remaining printable sheets and the number of remaining printable days can be calculated based on the use status of the replaced toner cartridge 2 and displayed to the user of the image forming apparatus 100. Accordingly, the user of the image forming apparatus 100 can see the estimated number of remaining printable sheets and printable days for a toner cartridge 2 being replaced. With this, according to the second embodiment, similarly to the first embodiment, it is possible to avoid replacement of a toner cartridge 2 for which a lot of toner usage effectively remains.

### Other Modification Examples

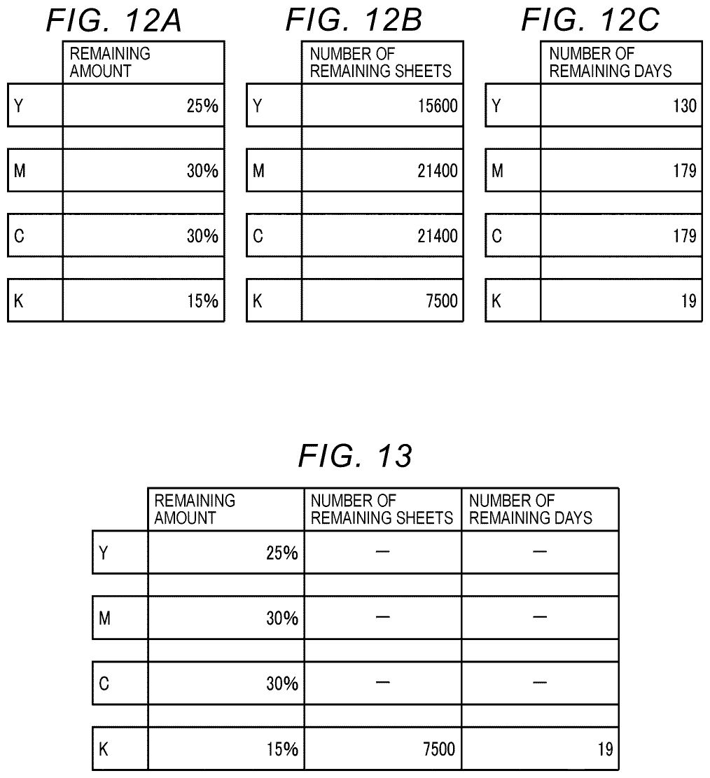

In the above-described embodiments, an example of information to be displayed is described with reference to FIGS. 9 and 10. The way(s) of displaying information is not limited to the examples of FIGS. 9 and 10, various modifications can be made. For example, the screen may be switched to display a plurality of kinds of information. FIGS. 12A, 12B, and 12C show examples of information that may be displayed on a serviceman terminal 400 or the like according to a modification example. In general, FIGS. 12A, 12B, and 12C show similar information to that of FIG. 9 but in a format different from FIG. 9. In FIG. 12A the remaining amount of toner is shown as a percentage of a full cartridge. In FIG. 12B the number of remaining printable sheets is shown. In FIG. 12C the number of remaining printable days is displayed. The serviceman terminal 400 may be switched, toggled, or rotated between these three kinds of information displays according to an operation or preference of the user. Similarly, the information shown in FIG. 12A, 12B, or 12C may be combined in whole or in part within a single display screen. In this way, information may be displayed at one time, but may be switched or displayed according to the operation of the user.

In the above-described embodiments, specific numerical values are displayed. However, the processor 301 of the server 300 or the like may substitute alternative information such as a symbol, icon, pictogram, or the like for a numerical value satisfying a particular condition or being within a preset range.

For example, in displaying information of the toner cartridge 2 mounted at present, it is considered that the user wants to know most information regarding the toner cartridge 2 in which the remaining amount is small, and only needs to know, as information regarding the toner cartridge 2 in which the remaining amount is sufficiently large, information indicating that the remaining amount is sufficient. Accordingly, if the number of remaining printable sheets is a sufficiently large value or if the number of remaining printable days is a sufficiently large value, the specific calculated numerical value may be substituted with alternative information such as “−”, so that it is possible to improve the readability of information compared to when all calculated numbers are displayed. For example, in processing information of the toner cartridge 2 in the image forming apparatus 100, if the number of remaining printable sheets is considered to be equal to or greater than 10000 sheets, or the number of remaining printable days is equal to or greater than 20 days, the processor 301 may substitute the calculated numerical values with alternative information indicating that the numerical value is sufficiently large not to be of concern to the user.

FIG. 13 is a diagram showing an example of information that is displayed on the serviceman terminal 400 according to a modification example. FIG. 13 shows a case where large numerical values for the number of remaining sheets and the number of remaining days are displayed in an alternative manner so as to be non-distracting to the user. In this way, it is possible to improve the readability of relevant information.

In displaying information of a detached toner cartridge 2, it may be considered that the user wants most to know the information about when the remaining amount of toner was high, thus it is the information indicating that the remaining amount of toner was small that may be displayed in a non-distracting manner in this context. Accordingly, if the number of remaining printable sheets is a sufficiently small value or if the number of remaining printable days is a sufficiently small value, the numerical value can be substituted with alternative information such as “−”, so that it is possible to improve the readability of information compared to when a complicated number is displayed. For example, in displaying information of a removed toner cartridge 2 detached from the image forming apparatus 100, if the number of remaining printable sheets is equal to or less than 1000 sheets or the number of remaining printable days is equal to or less than three days, the processor 301 may substitute the numerical value with alternative information indicating that the numerical value is sufficiently small.

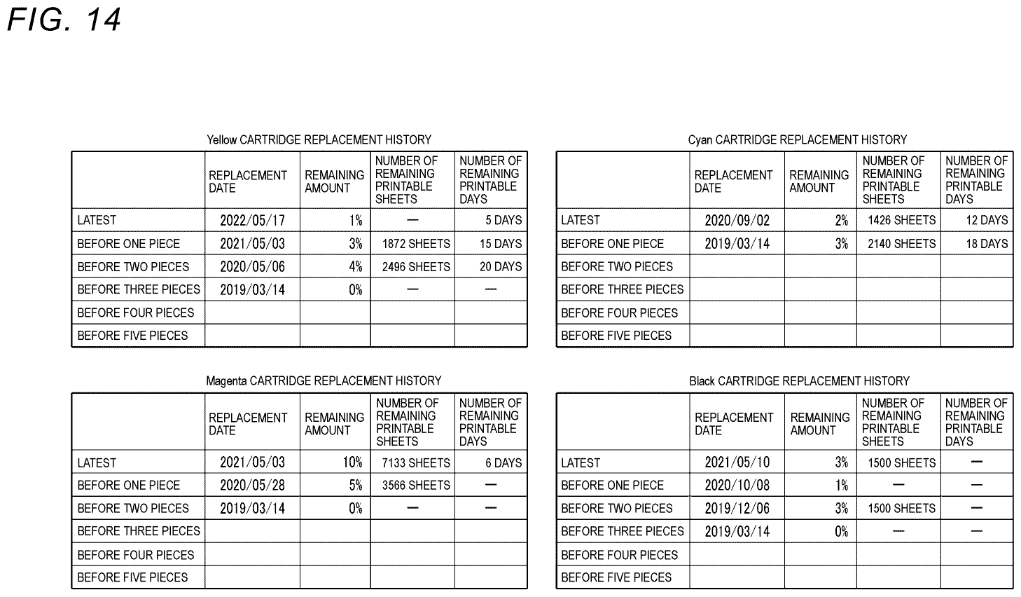

FIG. 14 is a diagram showing an example of information that is displayed on the serviceman terminal 400 according to a modification example. FIG. 14 shows a case where a sufficiently small numerical value is subjected to alternative processing a removed toner cartridge 2. In this way, the sufficiently small numerical value is subjected to alternative processing and displayed, so that it is possible to improve the readability of information to be focused.

In the above-described embodiments, when the average number of printed sheets is used in the calculation of the number of remaining printable days, a case where the sum of the number of sheets printed by black and white printing and the number of sheets printed by color printing is used in calculation for the toner cartridge 2 of black, and the number of sheets printed by color printing is used in calculation for the toner cartridges 2 of yellow, magenta, and cyan is described. The number of sheets printed by black and white printing and the number of sheets printed by color printing may be independently totalized, or a color printing ratio may be totalized such that the number of sheets printed by color printing is obtained by multiplying the number of sheets printed by black and white printing by the color printing ratio.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server for printer systems, the server comprising:
a communication interface connectable to an image forming apparatus and a user terminal; and
a processor configured to:
receive, via the communication interface from the image forming apparatus, a first number indicating the number of standard sheets printable using an installed toner cartridge of a first type under a standard condition, a first average print ratio for the image forming apparatus for the installed toner cartridge based on a usage history of the image forming apparatus, a first average number of printed sheets per day for the image forming apparatus based on the usage history, and a first remaining amount indicating the amount of toner left in the installed toner cartridge;
calculate a number indicating the remaining number of sheets printable using the installed toner cartridge according to the first number, the first average print ratio, and the first remaining amount;
calculate a number indicating the number of days for which the installed toner cartridge could be used before being empty according to the first number, the first average print ratio, the first average number of printed sheets per day, and the first remaining amount; and
transmit at least one of the calculated number indicating the remaining number of sheets printable using the installed toner cartridge or the calculated number of days for which the installed toner cartridge could be used before being empty via the communication interface to the user terminal.

2. The server according to claim 1, wherein the processor is further configured to:
receive, via the communication interface from the image forming apparatus, a second number indicating the number of standard sheets printable using a detached toner cartridge of the first type under the standard condition, a second average print ratio for the image forming apparatus for the detached toner cartridge based on the usage history of the image forming apparatus, a second average number of printed sheets per day for the image forming apparatus based on the usage history, and a second remaining amount indicating the amount of toner left in the detached toner cartridge;
calculate a number indicating the remaining number of sheets that would have been printable using the detached toner cartridge if it had remained installed, the number being calculated according to the second number, the second average print ratio, and the second remaining amount;
calculate a number indicating the number of days for which the detached toner cartridge could have been used before being empty according to the second number, the second average print ratio, the second average number of printed sheets per day, and the second remaining amount; and
transmit at least one of the calculated number indicating the remaining number of sheets that would have been printable using the detached toner cartridge or the calculated number of days for which the detached toner cartridge could have been used before being empty via the communication interface to the user terminal.

3. The server according to claim 2, wherein the processor is further configured to:
receive a date on which the detached toner cartridge was detached from the image forming apparatus, and
transmit the date to the user terminal.

4. The server according to claim 1, wherein the first number of standard printable sheets is calculated based on a first standard print ratio for a toner cartridge of the first type.

5. The server according to claim 1, wherein the processor is further configured to:
receive a date on which the installed toner cartridge was installed, and
transmit the date to the user terminal.

6. The server according to claim 1, wherein
the processor is further configured to:
receive, via the communication interface from the image forming apparatus, a second number indicating the number of standard sheets printable using a second installed toner cartridge of a second type under a standard condition, a second average print ratio for the image forming apparatus for the second installed toner cartridge based on the usage history of the image forming apparatus, a second average number of printed sheets per day for the image forming apparatus based on the usage history, and a second remaining amount indicating the amount of toner left in the second installed toner cartridge,
calculate a number indicating the remaining number of sheets that would be printable using the second installed toner cartridge according to the second number, the second average print ratio, and the second remaining amount;
calculate a number indicating the number of days for which the second installed toner cartridge could be used before being empty according to the second number, the second average print ratio, the second average number of printed sheets per day, and the second remaining amount; and
transmit at least one of the calculated number indicating the remaining number of sheets printable using the second installed toner cartridge or the calculated number of days for which the second installed toner cartridge could be used before being empty via the communication interface to the user terminal, and
the first type is different from the second type.

7. The server according to claim 6, wherein the first type and the second type are different toner color types.

8. A printer system, comprising:
an image forming apparatus connectable to a network and configured to print sheets using toner cartridges;
an information terminal including a display screen and connectable to the network; and
a server connectable to the network and including:
a communication interface connectable to the image forming apparatus and the information terminal via the network; and
a processor configured to:
receive, via the communication interface from the image forming apparatus, a first number indicating the number of standard sheets printable using an installed toner cartridge of a first type under a standard condition, a first average print ratio for the image forming apparatus for the installed toner cartridge based on a usage history of the image forming apparatus, a first average number of printed sheets per day for the image forming apparatus based on the usage history, and a first remaining amount indicating the amount of toner left in the installed toner cartridge;
calculate a number indicating the remaining number of sheets printable using the installed toner cartridge according to the first number, the first average print ratio, and the first remaining amount;
calculate a number indicating the number of days for which the installed toner cartridge could be used before being empty according to the first number, the first average print ratio, the first average number of printed sheets per day, and the first remaining amount; and
transmit at least one of the calculated number indicating the remaining number of sheets printable using the installed toner cartridge or the calculated number of days for which the installed toner cartridge could be used before being empty via the communication interface to the information terminal.

9. The printer system according to claim 8, wherein the processor is further configured to:
receive, via the communication interface from the image forming apparatus, a second number indicating the number of standard sheets printable using a detached toner cartridge of the first type under the standard condition, a second average print ratio for the image forming apparatus for the detached toner cartridge based on the usage history of the image forming apparatus, a second average number of printed sheets per day for the image forming apparatus based on the usage history, and a second remaining amount indicating the amount of toner left in the detached toner cartridge;
calculate a number indicating the remaining number of sheets that would have been printable using the detached toner cartridge if it had remained installed, the number being calculated according to the second number, the second average print ratio, and the second remaining amount;
calculate a number indicating the number of days for which the detached toner cartridge could have been used before being empty according to the second number, the second average print ratio, the second average number of printed sheets per day, and the second remaining amount; and
transmit at least one of the calculated number indicating the remaining number of sheets that would have been printable using the detached toner cartridge or the calculated number of days for which the detached toner cartridge could have been used before being empty via the communication interface to the information terminal.

10. The printer system according to claim 9, wherein the processor is further configured to:
receive a date on which the detached toner cartridge was detached from the image forming apparatus, and
transmit the date to the information terminal.

11. The printer system according to claim 8, wherein the first number of standard printable sheets is calculated based on a first standard print ratio for a toner cartridge of the first type.

12. The printer system according to claim 8, wherein the processor is further configured to:
receive a date on which the installed toner cartridge was installed, and
transmit the date to the information terminal.

13. The printer system according to claim 8, wherein
the processor is further configured to:
receive, via the communication interface from the image forming apparatus, a second number indicating the number of standard sheets printable using a second installed toner cartridge of a second type under a standard condition, a second average print ratio for the image forming apparatus for the second installed toner cartridge based on the usage history of the image forming apparatus, a second average number of printed sheets per day for the image forming apparatus based on the usage history, and a second remaining amount indicating the amount of toner left in the second installed toner cartridge;
calculate a number indicating the remaining number of sheets that would be printable using the second installed toner cartridge according to the second number, the second average print ratio, and the second remaining amount;
calculate a number indicating the number of days for which the second installed toner cartridge could be used before being empty according to the second number, the second average print ratio, the second average number of printed sheets per day, and the second remaining amount; and
transmit at least one of the calculated number indicating the remaining number of sheets printable using the second installed toner cartridge or the calculated number of days for which the second installed toner cartridge could be used before being empty via the communication interface to the information terminal, and
the first type is different from the second type.

14. The printer system according to claim 13, wherein the first type and the second type are different toner color types.

15. The printer system according to claim 8, wherein the information terminal is a mobile terminal.

16. The printer system according to claim 8, wherein both the number indicating the remaining number of sheets printable using the installed toner cartridge and the calculated number of days for which the installed toner cartridge could be used before being empty are transmitted to information terminal.

17. The printer system according to claim 16, wherein both the number indicating the remaining number of sheets printable using the installed toner cartridge or the calculated number of days for which the installed toner cartridge could be used before being empty are displayed on the display screen of the information terminal at the same time.

18. An image forming apparatus, comprising:
a storage unit;
a display screen; and
a processor configured to:
determine a type of an installed toner cartridge,
acquire a number of standard printable sheets under a standard condition for the determined type;
calculate a number of remaining printable sheets and a number of remaining printable days for the installed toner cartridge based on the number of standard printable sheets, an average print ratio for sheets printed using the installed toner cartridge, an average number of printed sheets per day, and a remaining amount of toner in the installed toner cartridge;
store, in the storage unit, the number of standard printable sheets, the average print ratio in the toner cartridge, the average number of printed sheets per day, and the remaining amount of toner in the installed toner cartridge when the installed toner cartridge is detached; and
cause the display screen to display at least one of the number of remaining printable sheets or the number of remaining printable days.

19. The image forming apparatus according to claim 18, further comprising:
a communication interface connectable to a server device, wherein
the processor is further configured to transmit at least one of the number of remaining printable sheets or the number of remaining printable days via the communication interface to the server.

20. The image forming apparatus according to claim 19, wherein the processor transmits the at least one of the number of remaining printable sheets or the number of remaining printable days via the communication interface to the server when the installed toner cartridge is detached.
